(19) United States
(12) Patent Application Publication
(10) Pub. No.: US 2016/0180544 A1
(43) Pub. Date: Jun. 23, 2016

(54) APPARATUS FOR CAMERA-ASSISTED TRAJECTORY ESTIMATION OF A SENSORIZED SPORTS PROJECTILE

(71) Applicant: Sstatzz Oy, Helsinki (FI)

(72) Inventors: Harri Hohteri, Helsinki (FI); Teemu Kemppainen, Espoo (FI); Tuukka Nieminen, Espoo (FI); Jirka Poropudas, Helsinki (FI)

(21) Appl. No.: 14/577,591

(22) Filed: Dec. 19, 2014

(51) Int. Cl. G06T 7/20; G06K 9/46; G06T 7/00; G06F 17/10; G06K 9/00

(52) U.S. Cl. CPC G06T 7/2033; G06F 17/10; G06K 9/00724; G06T 7/0042; G06K 9/46; G06T 2207/30241; G06K 2009/00738; G06K 2009/4666; G06T 2207/30224

(57) ABSTRACT

A sports apparatus is provided. The sports apparatus includes a computing device, an imaging device, and a projectile. The projectile includes a configuration of sensors for collecting sensor data, and a wireless interface for communicating the sensor data to the computing device. The computing device is operable to use the sensor data to detect a beginning of an event of interest, and to use the imaging device to start recording a sequence of still images along an expected trajectory of the projectile based on the detected beginning of the event of interest. The sequence of still images comprises at least one image where the projectile is detectable. Moreover, the computing device is operable to use the at least one image and the sensor data to determine a time-parameterized trajectory of the projectile, and to determine whether the time-parameterized trajectory intersects a specified region in space.

### TECHNICAL FIELD

The present disclosure relates generally to projectile tracking; and more specifically, to sports apparatus for determining a time-parameterized trajectory of a projectile and determining whether the time-parameterized trajectory intersects a specified region in space. Moreover, the present disclosure relates to computer-implemented methods for determining a time-parameterized trajectory of a projectile and determining whether the time-parameterized trajectory intersects a specified region in space. Furthermore, the present disclosure also relates to computer program products comprising non-transitory computer-readable data storage media having stored thereon computer-readable program code, which is executable by a processor of a computing device to implement the aforesaid methods.

### BACKGROUND

Various sports involve a projectile that is aimed at a goal structure, which can be either an actual physical structure or a conceptual region in space. Therefore, it is relevant to know whether the projectile passes through the goal structure. In some cases, one may also be interested in a top speed, an amount of spin, a location of the projectile at the goal structure, and other alike metrics of the moving projectile. For example, in baseball, the goal structure is a conceptual area over a home plate through which a pitch must pass in order to count as a strike when a batter does not swing. Additionally, in baseball, a speed and a curvature of a pitch and a location of a baseball at an edge of the goal structure are important metrics to evaluate a performance of a pitcher.

The passage of the projectile through the goal structure and other metrics are usually determinable from a corresponding time-parametrized trajectory of the projectile in a straightforward manner. However, it is highly nontrivial to produce the respective trajectory accurately and reliably, while using only affordable consumer-grade sports apparatus and systems.

Conventional systems for detecting a position of a baseball at a strike zone are typically based on imaging devices. These systems often employ mobile terminals with imaging devices for recording sequences of still images. However, in such systems, power consumption of the mobile terminals is a large problem. If an imaging device of a mobile terminal is kept on throughout a game play, a use time of the mobile terminal will be very limited. As a result, the mobile terminal will require frequent recharging or replacement even during a single session of the game play.

Some conventional systems also employ special indicators using ultrasonic signals, frames with reflective surfaces or complex radar systems. Still other types of systems employ multiple imaging devices to follow the pitch. However, these systems require the imaging devices to be installed at precise locations. Due to a large amount of delicate equipment, these conventional systems are expensive to purchase.

In US patent application 20140045630 A1, an Inertial Measurement Unit (IMU) based baseball pitcher training apparatus is described. The operation of the apparatus described therein is based on an assumption that a projectile is kept stationary on a tee prior to a pitching event. During this stationary period, necessary initial values are provided for an attitude, velocity, and position of the projectile. As described, the initial attitude is based on components of a gravitational acceleration measured by an accelerometer. Therefore, the described apparatus does not specify an initial rotation angle over a local vertical direction (i.e., an azimuth or yaw angle). This makes the apparatus incapable of detecting a pitch direction. In other words, the described apparatus is incapable of detecting whether or not the projectile passes through a goal structure. Moreover, the described apparatus exploits a number of pitch-specific velocity constraints throughout the pitching motion in order to remove typical drift errors observed when employing low-cost IMUs. Herein, a problem encountered is that it is technically infeasible to accurately locate such specific constraints in an automated manner for any given pitcher. Yet a failed timing of the aformentioned velocity constraints often leads to unrealistic results. Moreover, different sporting events generally require different constraints, and heavy assumptions regarding these constraints lead to situations where a pitcher might receive completely incorrect results only because of his/hers unexpected style. Furthermore, the assumed positioning of the projectile on a specific tee prior to the pitching event is a particularly cumbersome requirement especially in sports where the pitching event regularly follows a preceding pass without any significant delay, effectively voiding a possibility to use the apparatus in many fast game-like situations.

### SUMMARY

The present disclosure seeks to provide an improved sports apparatus for determining a time-parameterized trajectory of a projectile and determining whether the time-parameterized trajectory intersects a specified region in space.

The present disclosure also seeks to provide an improved method for determining a time-parameterized trajectory of a projectile and determining whether the time-parameterized trajectory intersects a specified region in space.

A further aim of the present disclosure is to at least partially overcome at least some of the problems of the prior art, as discussed above.

In a first aspect, embodiments of the present disclosure provide a sports apparatus for determining a time-parameterized trajectory of a projectile and determining whether the time-parameterized trajectory intersects a specified region in space, the sports apparatus comprising:

a computing device;
an imaging device; and
a projectile, comprising:

a configuration of sensors for collecting sensor data; and

a wireless interface for communicating the sensor data to the computing device,

wherein the computing device is operable to use the sensor data to detect a beginning of an event of interest, and to use the imaging device to start recording a sequence of still images along an expected trajectory of the projectile based on the detected beginning of the event of interest,
wherein the sequence of still images comprises at least one image where the projectile is detectable,
further wherein the computing device is operable to use the at least one image and the sensor data to determine a time-parameterized trajectory of the projectile, and to determine whether the time-parameterized trajectory intersects a specified region in space.

In a second aspect, embodiments of the present disclosure provide a computer-implemented method for determining a time-parameterized trajectory of a projectile and determining whether the time-parameterized trajectory intersects a specified region in space, the projectile comprising a configuration of sensors, the method comprising:

(a) receiving sensor data from the projectile;
(b) using the sensor data to detect a beginning of an event of interest;
(c) starting recording of a sequence of still images along an expected trajectory of the projectile based on the detected beginning of the event of interest, wherein the sequence of still images comprises at least one image where the projectile is detectable;
(d) using the at least one image and the sensor data to determine the time-parameterized trajectory of the projectile; and
(e) determining whether the time-parameterized trajectory intersects the specified region in space.

In a third aspect, embodiments of the present disclosure provide a computer program product comprising a non-transitory computer-readable data storage medium having stored thereon computer-readable program code, which is executable by a processor of a computing device to implement the aforementioned method

Embodiments of the present disclosure substantially eliminate or at least partially address the aforementioned problems in the prior art, and enable accurate determination of a time-parameterized trajectory of a projectile, while reducing power consumption of a sports apparatus.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an example playing scenario in which a sports apparatus is implemented pursuant to the present disclosure;

FIG. 2 is a schematic illustration of another example playing scenario in which a sports apparatus is implemented pursuant to the present disclosure;

FIG. 3 is a schematic illustration of an example implementation of a projectile and various components thereof, in accordance with an embodiment of the present disclosure;

FIG. 4 is a schematic illustration of how a specified region in space is painted using an object of known dimensions and a user interface of a computing device, in accordance with an embodiment of the present disclosure;

FIG. 5 is a schematic illustration of a pinhole camera projection model;

FIG. 6 is a schematic illustration of a pinhole projection of a spherical projectile, in accordance with an embodiment of the present disclosure;

FIG. 7 is an illustration of various phases of an example implementation of a sports apparatus, in accordance with an embodiment of the present disclosure; and

FIGS. 8A-D are schematic illustrations of an example user interface, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure has been disclosed, those skilled in the art would recognize that other embodiments for carrying out or practicing the present disclosure are also possible.

In a first aspect, embodiments of the present disclosure provide a sports apparatus for determining a time-parameterized trajectory of a projectile and determining whether the time-parameterized trajectory intersects a specified region in space, the sports apparatus comprising:

a computing device;
an imaging device; and
a projectile, comprising:

a configuration of sensors for collecting sensor data; and

a wireless interface for communicating the sensor data to the computing device,

wherein the computing device is operable to use the sensor data to detect a beginning of an event of interest, and to use the imaging device to start recording a sequence of still images along an expected trajectory of the projectile based on the detected beginning of the event of interest,
wherein the sequence of still images comprises at least one image where the projectile is detectable,
further wherein the computing device is operable to use the at least one image and the sensor data to determine a time-parameterized trajectory of the projectile, and to determine whether the time-parameterized trajectory intersects a specified region in space.

Herein, the term “event of interest” generally refers to a situation in which a projectile is thrown, shot, hit, kicked, or otherwise driven into a ballistic trajectory or a trajectory where the projectile is sliding, rolling, or bouncing on the ground. In general, the event of interest includes an instant of time when the projectile looses contact with a player or his/her sports instrument (hereinafter referred to as “instant of release” and “Tᵣ”). Optionally, the event of interest extends to an application-dependent amount of time before (T₀≦Tᵣ) and after (Tᵣ<T₁) the instant of release.

Examples of the computing device include, but are not limited to, a mobile phone, a smart telephone, a Mobile Internet Device (MID), a tablet computer, an Ultra-Mobile Personal Computer (UMPC), a phablet computer, a Personal Digital Assistant (PDA), a web pad, a handheld Personal Computer (PC), and a laptop computer.

The imaging device is capable of recording still images and/or videos. For the sake of clarity, the term “sequence of still images” is used to refer to recorded still images, movies and/or videos, without departing from the scope of the present disclosure. It is to be noted that in some situations, the sequence of still images may realise as a single image.

According to an embodiment, the imaging device is operable to record the sequence of still images using frequencies other than visible light. In one example, the imaging device is operable to record the sequence of still images using Infra-Red (IR) radiation.

Examples of the imaging device include, but are not limited to, a still camera, a video camera, a phone camera, a digital camera, a web camera, an Internet Protocol (IP) camera and an IR camera.

The computing device and the imaging device may either be located on a same physical device or be located on separate physical devices, which may be communicably coupled together, for example, via a cable, a wireless interface, or a communication network.

According to an embodiment, the configuration of sensors comprises an accelerometer, an angular rate sensor, and a magnetometer. In this embodiment, the sensor data comprises accelerometer data, angular rate sensor data, and magnetometer data.

According to another embodiment, the configuration of sensors comprises an accelerometer and an angular rate sensor. In this embodiment, the sensor data comprises accelerometer data and angular rate sensor data.

According to yet another embodiment, the configuration of sensors comprises an accelerometer and a magnetometer. In this embodiment, the sensor data comprises accelerometer data and magnetometer data.

According to still another embodiment, the configuration of sensors comprises an accelerometer. In this embodiment, the sensor data comprises accelerometer data.

According to an embodiment, the computing device is operable to process the time-parameterized trajectory to determine one or more event-specific metrics.

According to an embodiment, the computing device is operable to detect an image position and an image size of the projectile at one or more images of the sequence of still images to estimate position coordinates of the projectile.

According to an embodiment, the computing device comprises a user interface for determining the specified region in space and calibrating the sports apparatus. In an embodiment, the computing device is operable to employ the user interface to indicate, within an image range of the imaging device, a presence of a physical goal structure with known physical dimensions. In another embodiment, the computing device is operable to detect an object with known dimensions, and to employ the user interface to specify borders of the specified region in space using the detected object. In yet another embodiment, the computing device is operable to use a specific calibration structure with known physical dimensions, and to employ the user interface to define a location of the specific calibration structure.

According to an embodiment, the specified region in space is defined arbitrarily.

According to a first embodiment, the projectile is a ball selected from a group consisting of a baseball, a softball and a cricket ball. In the first embodiment, the event of interest is a pitch or a strike of the ball, and the specified region in space is a strike zone above a home plate or an area in front of a wicket.

According to a second embodiment, the projectile is a tennis ball or a volleyball. In the second embodiment, the event of interest is a serve or a hit of the tennis ball or the volleyball, and the specified region in space is a region above a net or a region defined within a court.

According to a third embodiment, the projectile is selected from a group consisting of a hockey puck, a lacrosse ball and a handball. In the third embodiment, the event of interest is a shot of the projectile, and the specified region in space is a goal.

According to a fourth embodiment, the projectile is a soccer ball or a football. In the fourth embodiment, the event of interest is a kick of the soccer ball or the football, and the specified region in space is a goal.

According to a fifth embodiment, the projectile is a golf ball. In the fifth embodiment, the event of interest is a hit of the golf ball, and the specified region in space is selected from a group consisting of a green, a flag and a hole.

According to a sixth embodiment, the projectile is a bowling ball. In the sixth embodiment, the event of interest is a shot of the bowling ball, and the specified region in space is a region defined at an end of a bowling lane.

According to a seventh embodiment, the projectile is a basketball. In the seventh embodiment, the event of interest is a shot of the basket ball, and the specified region in space is a region inside a rim.

In a second aspect, embodiments of the present disclosure provide a computer-implemented method for determining a time-parameterized trajectory of a projectile and determining whether the time-parameterized trajectory intersects a specified region in space, the projectile comprising a configuration of sensors, the method comprising:

(a) receiving sensor data from the projectile;
(b) using the sensor data to detect a beginning of an event of interest;
(c) starting recording of a sequence of still images along an expected trajectory of the projectile based on the detected beginning of the event of interest, wherein the sequence of still images comprises at least one image where the projectile is detectable;
(d) using the at least one image and the sensor data to determine the time-parameterized trajectory of the projectile; and
(e) determining whether the time-parameterized trajectory intersects the specified region in space.

According to an embodiment, the sensor data comprises accelerometer data, angular rate sensor data, and magnetometer data. According to another embodiment, the sensor data comprises accelerometer data and angular rate sensor data. According to yet another embodiment, the sensor data comprises accelerometer data and magnetometer data. According to still another embodiment, the sensor data comprises accelerometer data.

According to an embodiment, the method further comprises processing the time-parameterized trajectory to determine one or more event-specific metrics.

According to an embodiment, the method further comprises detecting an image position and an image size of the projectile at one or more images of the sequence of still images to estimate position coordinates of the projectile.

According to an embodiment, the sequence of still images is recorded using frequencies other than visible light.

According to an embodiment, the method further comprises providing a user interface for determining the specified region in space. In an embodiment, the method further comprises employing the user interface to indicate, within an image range, a presence of a physical goal structure with known physical dimensions. In another embodiment, the method further comprises detecting an object with known dimensions, and employing the user interface to specify borders of the specified region in space using the detected object. In yet another embodiment, the method further comprises using a specific calibration structure with known physical dimensions, and employing the user interface to define a location of the specific calibration structure.

According to an embodiment, the specified region in space is defined arbitrarily.

According to a first embodiment, the projectile is a ball selected from a group consisting of a baseball, a softball and a cricket ball. In the first embodiment, the event of interest is a pitch or a strike of the ball, and the specified region in space is a strike zone above a home plate or an area in front of a wicket.

According to a second embodiment, the projectile is a tennis ball or a volleyball. In the second embodiment, the event of interest is a serve or a hit of the tennis ball or the volleyball, and the specified region in space is a region above a net or a region defined within a court.

According to a third embodiment, the projectile is selected from a group consisting of a hockey puck, a lacrosse ball and a handball. In the third embodiment, the event of interest is a shot of the projectile, and the specified region in space is a goal.

According to a fourth embodiment, the projectile is a soccer ball or a football. In the fourth embodiment, the event of interest is a kick of the soccer ball or the football, and the specified region in space is a goal.

According to a fifth embodiment, the projectile is a golf ball. In the fifth embodiment, the event of interest is a hit of the golf ball, and the specified region in space is selected from a group consisting of a green, a flag and a hole.

According to a sixth embodiment, the projectile is a bowling ball. In the sixth embodiment, the event of interest is a shot of the bowling ball, and the specified region in space is a region defined at an end of a bowling lane.

According to a seventh embodiment, the projectile is a basketball. In the seventh embodiment, the event of interest is a shot of the basket ball, and the specified region in space is a region inside a rim.

In a third aspect, embodiments of the present disclosure provide a computer program product comprising a non-transitory computer-readable data storage medium having stored thereon computer-readable program code, which is executable by a processor of a computing device to implement the aforementioned method.

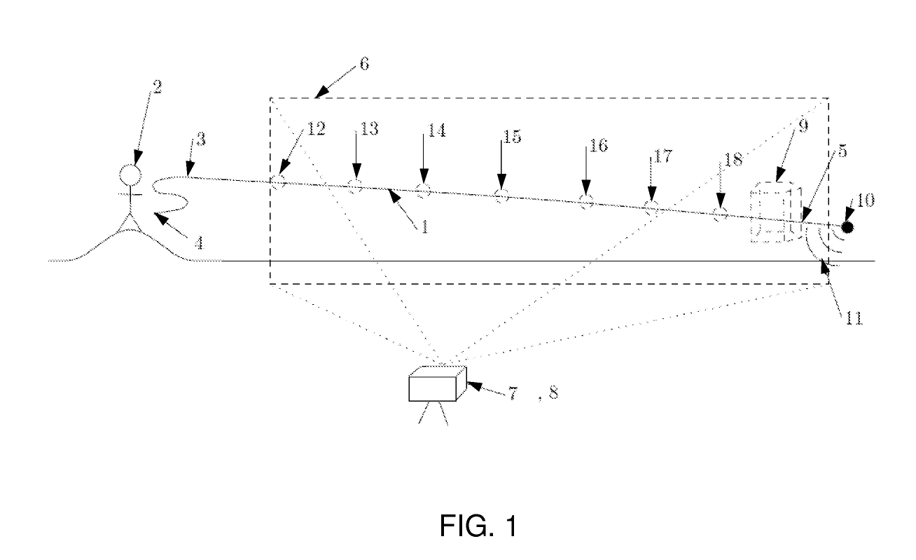

Referring now to the drawings, particularly by their reference numbers, FIG. 1 is a schematic illustration of an example playing scenario in which a sports apparatus is implemented pursuant to the present disclosure. The sports apparatus includes a computing device 7, an imaging device 8 and a projectile 10. The projectile 10 includes a configuration of sensors for collecting sensor data.

With reference to FIG. 1, the computing device 7 and the imaging device 8 are located on a same physical device.

For illustrative purposes only, the imaging device 8 is positioned in a manner that the imaging device 8 is operable to record a sequence of still images of a trajectory 1 of the projectile 10 from a side. A person skilled in the art will recognize many variations, alternatives, and modifications of embodiments of how the imaging device 8 may be positioned.

In FIG. 1, there is shown a start point 4 of the trajectory 1. The start point 4 is a point from where a pitcher 2 starts a pitching motion, and is located in front of the pitcher 2. There is also shown a release point 3 at which the pitcher 2 releases the projectile 10. The projectile 10 is in flight after the release point 3.

Moreover, there is shown an end point 5 of the trajectory 1. The end point 5 may be defined as a point at which a distance between the projectile 10 and a goal structure 9 starts increasing. The goal structure 9 is a specified region in space. In an example where the sports apparatus is implemented in a baseball game, the goal structure 9 is a conceptual region over a home plate.

In FIG. 1, there is also shown an image space 6 of the imaging device 8, and various positions 12, 13, 14, 15, 16, 17 and 18 of the projectile 10 in the sequence of still images.

Moreover, there is shown a wireless link 11 between the projectile 10 and the computing device 7. The wireless link 11 is used to communicate the sensor data to the computing device 7 wirelessly.

FIG. 1 is merely an example, which should not unduly limit the scope of the claims herein. It is to be understood that the implementation of the sports apparatus is provided as an example and is not limited to a specific number and/or arrangement of computing devices and imaging devices. A person skilled in the art will recognize many variations, alternatives, and modifications of embodiments of the present disclosure.

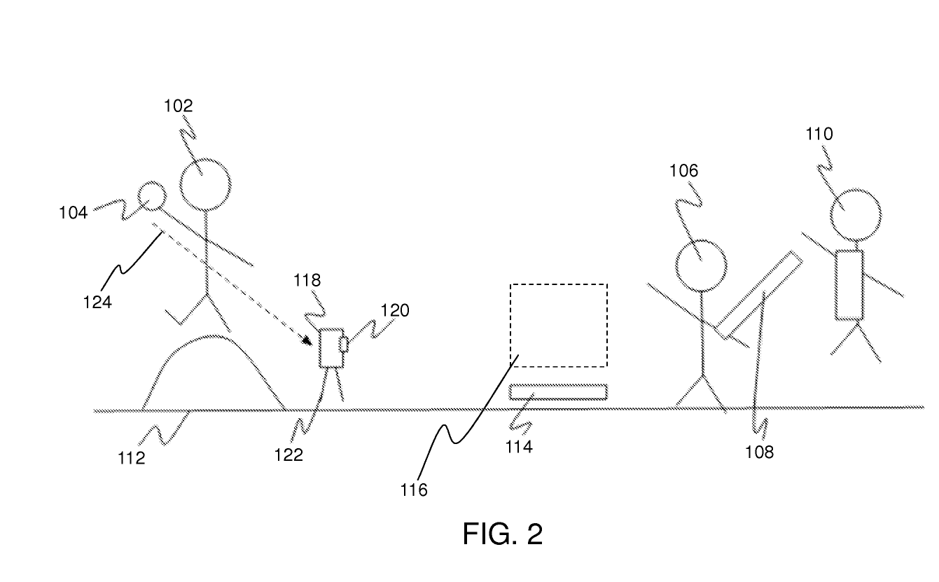

FIG. 2 is a schematic illustration of another example playing scenario in which a sports apparatus is implemented pursuant to the present disclosure. In FIG. 2, there are shown a pitcher 102 with a projectile 104, a batter 106 with a bat 108, and an umpire 110 within a spatial playing region.

With reference to FIG. 2, the projectile 104 is a baseball, and the spatial playing region is a part of a baseball field that includes a pitcher's mound 112 and a home plate 114 that is laid on a ground. It is to be noted here that the sports apparatus can alternatively be implemented with any sport, including softball, cricket, tennis, volleyball, lacrosse, hockey, handball, soccer, football, golf, bowling, and basketball, but not limited thereto.

In FIG. 2, there is also shown a specified region in space 116. In an example where the sports apparatus is implemented in a baseball game, the specified region in space 116 is a strike zone, which defines one or more boundaries through which a pitch must pass in order to be indicated as an accurate pitch. As an example, an accurate pitch is counted as a strike when the batter 106 does not swing the bat 108.

Optionally, the specified region in space 116 is aligned with the home plate 114. Optionally, the specified region in space 116 is defined as a conceptual pentagonal prism located over the home plate 114. Alternatively, optionally, the specified region in space 116 is defined as a face of the conceptual pentagonal prism that faces towards the pitcher 102.

The sports apparatus includes a computing device 118 and an imaging device 120. With reference to FIG. 2, the computing device 118 and the imaging device 120 are located on a same physical device.

With reference to FIG. 2, the computing device 118 is installed on a tripod 122, such that the imaging device 120 faces towards the specified region in space 116. Thus, the imaging device 120 is operable to record a sequence of still images along a direction of a trajectory of the projectile 104.

The sports apparatus also includes the projectile 104. The projectile 104 includes a configuration of sensors for collecting sensor data. The projectile 104 also includes a wireless interface for communicating the sensor data to the computing device 118 wirelessly, depicted by a wireless link 124 in FIG. 2.

FIG. 2 is merely an example, which should not unduly limit the scope of the claims herein. It is to be understood that the implementation of the sports apparatus is provided as an example and is not limited to a specific number and/or arrangement of computing devices and imaging devices. A person skilled in the art will recognize many variations, alternatives, and modifications of embodiments of the present disclosure.

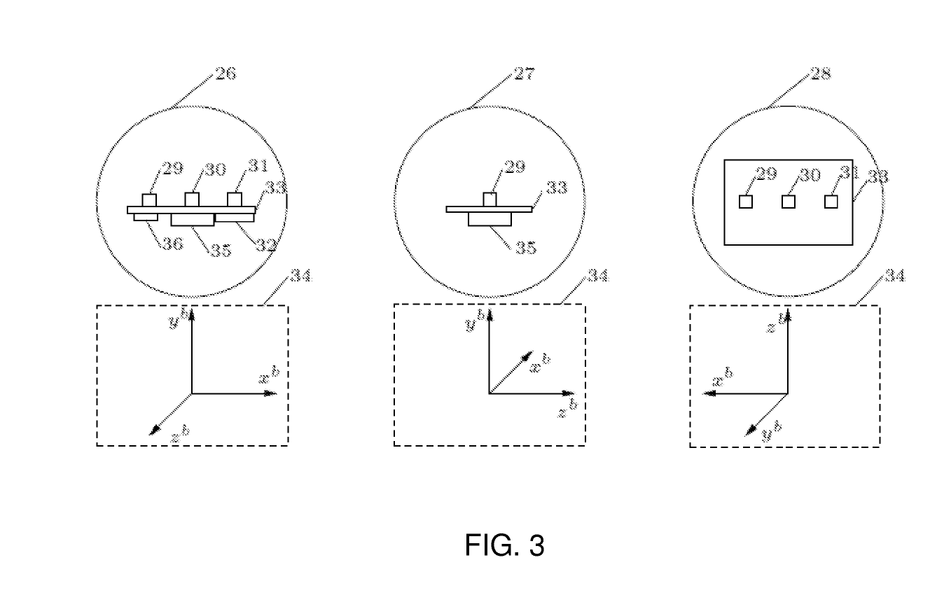

FIG. 3 is a schematic illustration of an example implementation of a projectile and various components thereof, in accordance with an embodiment of the present disclosure. The projectile could be implemented in a manner that is similar to the implementation of the projectile (10, 104) and vice versa.

In FIG. 3, there are shown a front view 26, a side view 27, and a top view 28 of the projectile along with example orientations of a body-fixed coordinate frame 34 in each of the views 26, 27 and 28.

The projectile includes, but is not limited to, a configuration of sensors, including an accelerometer 30, an angular rate sensor 29 and a magnetometer 31, a controller 32, a wireless interface 35, and a power source 36.

The wireless interface 35 is a radio communication interface. Optionally, the wireless interface 35 is a “Bluetooth” interface that enables the projectile to use its own “Bluetooth” network. (“Bluetooth” is a registered trademark).

The power source 36 supplies electrical power to the various components of the projectile. Optionally, the power source 36 includes one or more batteries. These batteries may be either rechargeable or non-rechargeable.

For demonstration purposes, possible locations of the accelerometer 30, the angular rate sensor 29 and the magnetometer 31 on a top side of a Printed Circuit Board (PCB) 33 are depicted in FIG. 3. Moreover, possible locations of the controller 32, the wireless interface 35 and the power source 36 on a bottom side of the PCB 33 are depicted in FIG. 3.

It is to be noted here that due to a potentially high rotation rate of the projectile, a distance between the accelerometer 30 and a mass centre of the projectile is kept small to prevent sensor saturation and an unnecessary growth of measurement errors. The sensor saturation typically results from a centripetal acceleration, which is proportional to Ω²r, where ‘Ω’ is a rotation rate and ‘r’ is the distance between the accelerometer 30 and the mass centre of the projectile.

Depending on an operation principle of the angular rate sensor 29, it may be required that a distance between the angular rate sensor 29 and the mass centre of the projectile is also kept small. This may be a case when the angular rate sensor 29 tends to be sensitive to linear accelerations.

FIG. 3 is merely an example, which should not unduly limit the scope of the claims herein. It is to be understood that the specific designation for the projectile is for the convenience of reader and is not to be construed as limiting the projectile to specific numbers, types, or arrangements of components of the projectile. A person skilled in the art will recognize many variations, alternatives, and modifications of embodiments of the present disclosure.

There will now be described below various phases of an example implementation of the sports apparatus, pursuant to embodiments of the present disclosure. The various phases include:

1. calibrating the sports apparatus to determine a location of the imaging device (8, 120) with respect to the specified region in space (9, 116) and to establish a wireless link (11, 124) between the projectile (10, 104) and the computing device (7, 118);
2. substantially continuously processing the sensor data to detect a beginning of an event of interest in order to start recording a sequence of still images along an expected trajectory of the projectile (10, 104);
3. stopping recording of the sequence of still images, based either on a detection of an impact of the projectile (10, 104) with another object using the sensor data or on a completion of a predetermined maximum recording time;
4. analyzing the sequence of still images to estimate position coordinates (hereinafter interchangeably referred to as “position data”) of the projectile (10, 104) at one or more images of the sequence of still images where the projectile (10, 104) is detectable;
5. using the sensor data and the position data to determine a time-parameterized trajectory (1) of the projectile (10, 104);
6. analyzing the time-parameterized trajectory (1) and determining whether the time-parameterized trajectory (1) intersects with the specified region in space (9, 116);
7. collecting data related to the time-parameterized trajectory (1) and storing in a database; and
8. repeating the phase 2.

In accordance with the phase 2, the processing of the sensor data can take place either in the computing device (7, 118) or in the projectile (10, 104). It is to be noted here that some of the aforementioned phases may be removed, replaced, or processed in a different order without deviating from the scope of the present disclosure.

There will next be provided a detailed description of each of the aforementioned phases.

### Phase 1: Calibration of the Sports Apparatus

In order to determine the time-parameterized trajectory (1) of projectile (10, 104) and to determine whether the time-parameterized trajectory (1) passes through the specified region in space (9, 116), it is required that positions of the projectile (10, 104), the imaging device (8, 120) and the specified region in space (9, 116) are defined in a same global coordinate system. For the sake of convenience, the global coordinate system may be aligned with the specified region in space (9, 116). It is to be noted here that the global coordinate system can be freely chosen.

For the sake of convention and compactness of expression, there will now be considered that the imaging device (8, 120) is a camera, without limiting the scope of the present disclosure.

Calibration of the camera includes calibrating intrinsic and/or extrinsic parameters of the camera.

The calibration of the intrinsic parameters (hereinafter referred to as “intrinsic parameter calibration”) is well-known in the art, and can be done by using a specific calibration pattern. The intrinsic parameter calibration includes solving the intrinsic parameters of the camera that are needed to compensate lens distortions incurred in camera lens and to use simple pinhole camera projection models. The intrinsic parameter calibration is required to be done only once, if certain lens parameters stay constant or near constant. In one example, the lens parameters are constant when fixed focus lenses are used. Such fixed focus lenses are typically found in smart telephones. In another example, the lens parameters are constant when a focus of the camera lens is set to one of its limits. It is to be noted here that it is possible to use other projection models and distortion compensation methods without deviating from the scope of the present disclosure.

The calibration of the extrinsic parameters (hereinafter referred to as “extrinsic parameter calibration”) includes solving a camera pose, for example, such as a rotation and a translation, with respect to the global coordinate system. The extrinsic parameter calibration is well-known in the art, and can be done in various ways without deviating from the scope of the present disclosure.

According to an embodiment, the camera pose is found by solving a Perspective-n-Point (PnP) problem by using at least three 3D-2D point correspondences between 3D points in the global coordinate system and their projections on an image plane of the camera. In this embodiment, the 3D points in the global coordinate system can be any of:

(i) points of a physical goal structure,
(ii) points of a specific calibration structure, or
(iii) other points from which distances to the specified region in space are determinable.

In one example, the aforementioned 3D points can be corners or other distinct parts of the physical goal structure whose relative distances can be measured and are visible and detectable in a camera image. Finding the 2D projections of these 3D points in the image plane can be done either manually or automatically.

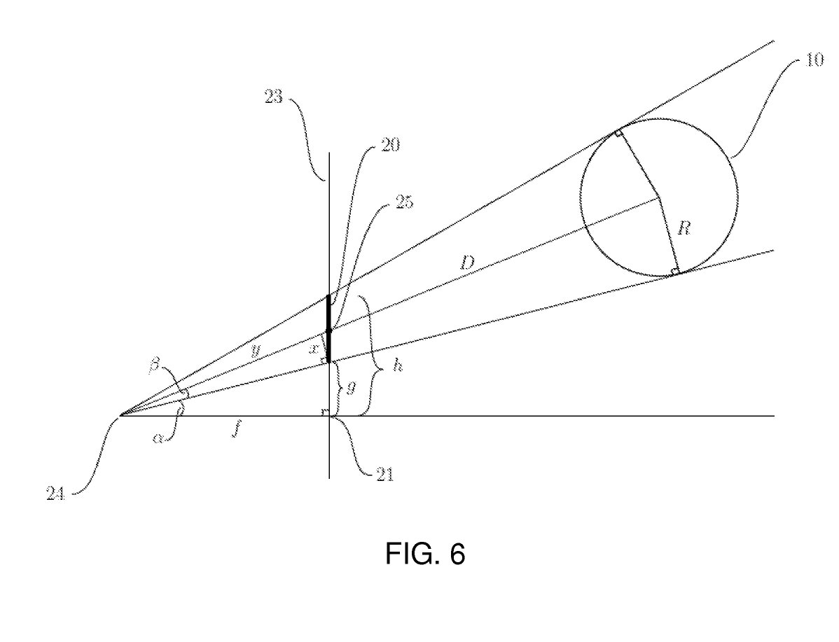

According to another embodiment, the camera pose is found by solving a proper rigid 3D transformation by using at least three 3D-3D point correspondences between 3D points in the global coordinate system and the same 3D points in a camera coordinate system. Coordinates of the 3D points in the camera coordinate system (hereinafter referred to as “camera coordinates”) are often not possible to determine by measuring distances, as an origin of the camera coordinate system is at an optical centre of the camera, which is inside the camera, and is not usually accessible. One possible way to determine the camera coordinates is to use an object with known dimensions, whose camera coordinates can be determined from its projection on the image plane of the camera. An example of such an object is the projectile (10, 104) whose dimensions are known. An example of determination of the 3D coordinates of the object in the camera coordinate system has been provided in connection with FIG. 6.

The object is placed at different positions whose coordinates are known in the global coordinate system, for example, at the corners of the physical goal structure. It will be appreciated that using the object, it is also possible to specify borders of the specified region in space (9, 116), and thus, to “paint” the specified region in space (9, 116). This effectively defines the specified region in space (9, 116) in the global coordinate system.

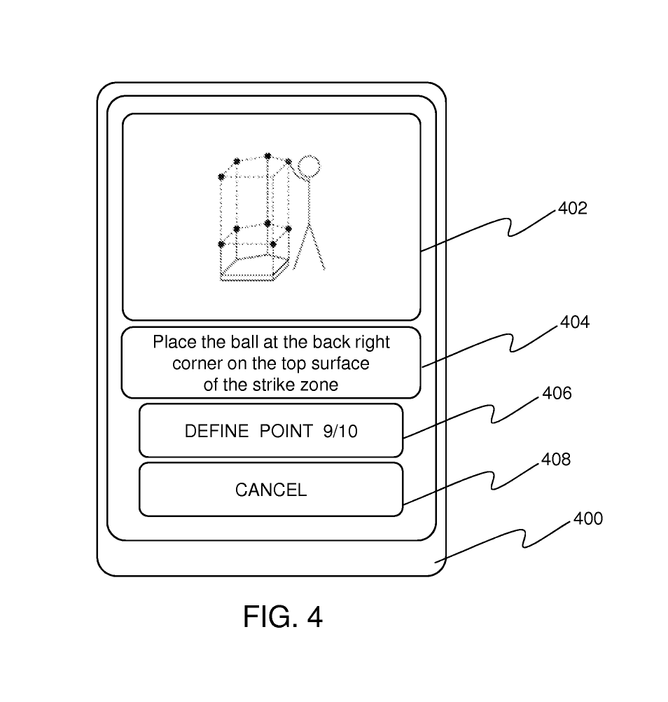

FIG. 4 is a schematic illustration of how the specified region in space (9, 116) is painted using a ball of known dimensions and a user interface of a computing device 400, in accordance with an embodiment of the present disclosure. The ball is placed at corners of the specified region in space (9, 116), while the user interface is used to guide a user through a process of calibrating the sports apparatus and defining the specified region in space (9, 116).

The user interface includes a view 402 of the image space (6) of the imaging device (8, 120), a box 404 for displaying instructions to the user, a progress button 406 and a cancel button 408.

With reference to FIG. 4, a text “Place the ball at the back right corner on the top surface of the strike zone” is displayed in the box 404, and a text “DEFINE POINT 9/10” is displayed on the progress button 406. This indicates that the back right corner of the specified region in space (9, 116) is being defined.

FIG. 4 is merely an example, which should not unduly limit the scope of the claims herein. A person skilled in the art will recognize many variations, alternatives, and modifications of embodiments of the present disclosure.

Moreover, in a case where the user is interested only in the time-parameterized trajectory (1) and not in whether the projectile (10, 104) passes through the specified region in space (9, 116), the extrinsic parameter calibration can be skipped. In such a case, the global coordinate system can be defined as the camera coordinate system and the time-parameterized trajectory (1) is determined relative to the camera pose.

Furthermore, optionally, the configuration of sensors included with the projectile (10, 104) is also calibrated. For this purpose, the projectile (10, 104) is kept stationary on the ground in different positions, and the sensor data is collected. This potentially enables determination of bias offset terms of individual sensors included within the configuration of sensors. Moreover, this potentially enables determination of scale factors of a magnetometer and/or intrinsic angles of an accelerometer. The abovementioned calibration process is well-known in the art. A person skilled in the art will recognize many variations, alternatives, and modifications of the abovementioned calibration process.

### Phase 2: Detection of the Beginning of the Event of Interest

During a typical event of interest, a velocity of the projectile (10, 104) changes drastically. As an example, the velocity may change from zero to over 100 m/s in less than one second. This means that an average total acceleration during the event of interest is approximately 10 g (≈100 m/s²), which is well beyond an expected average total acceleration during a normal manoeuvre of the projectile (10, 104). The expected average total acceleration during the normal manoeuvre is typically in a range of 1 g to 2 g (≈10 m/s² to 20 m/s²), wherein a lower limit typically results from a gravitational acceleration of approximately 1 g.

In an example where the event of interest is a pitching motion of the projectile, the total acceleration measured during the event of interest is substantially smooth and is followed by a continuous flight phase after the instant of release. The flight phase is detectable from the accelerometer data and/or the angular rate sensor data as a patch of substantially constant measurements. These characteristics of the sensor data distinguish the event of interest from the continuous flight phase.

Once the event of interest is detected, the computing device (7, 118) employs the imaging device (8, 120) to start recording a sequence of still images. Depending on a setup of the sports apparatus and involved delays, the imaging device (8, 120) is either shut down or in standby between recording intervals.

As the recording of the sequence of still images is turned ON after the beginning of the event of interest is detected, the imaging device (8, 120) consumes less power, when compared to prior art sports apparatus for capturing sports videos.

In a specific embodiment, the imaging device (8, 120) is continuously recording the sequence of still images and the detected beginning of the event of interest is used to initiate a processor-intensive image sequence analysis. In such a case, energy savings are obtained by pointing out a time interval when the processor-intensive image sequence analysis should take place.

### Phase 3: Stopping Criterion

According to an embodiment, the recording of the sequence of still images is stopped based on a detection of an impact of the projectile (10, 104) with another object. In an example, when the projectile (10, 104) hits another object, for example, such as a physical goal structure or a sports equipment, such as a bat or a hand glove, the impact of the projectile (10, 104) can be detected from a sudden variation in the sensor data. In another example, where there is no physical goal structure or sports equipment, when the projectile (10, 104) reaches an end point of its trajectory, namely when a distance between the projectile (10, 104) and the specified region in space (9, 116) starts increasing, the impact of the projectile (10, 104) can be detected from the sensor data.

According to another embodiment, the recording of the sequence of still images is stopped when a predetermined maximum recording time is passed. In an example, the maximum recording time is preset manually by a user. In another example, the maximum recording time is defined based on results obtained during preceding events of interest.

According to yet another embodiment, the recording of the sequence of still images is stopped based on a real-time analysis of the recorded sequence of still images. For this purpose, the computing device (7, 118) requires a sufficient processing power.

### Phase 4: Image Sequence Analysis

In the image sequence analysis, the projectile (10, 104) is detected in the one or more images of the sequence of still images. The position coordinates of the projectile (10, 104) are then determined in the global coordinate system.

In general, the image sequence analysis is substantially computation intensive as an amount of image data is usually large. For illustration purposes only, there will now be considered an example of an RGB color image stream with a resolution of 1920×1080 and a frame rate of 120 frames per second. In the example, considering that each pixel requires one byte (eight bits) for storage, the RGB color image stream would result in a data stream of (1920·1080·3·120)/(1024·1024) MB/s=711.91 MB/s. Even with a lower resolution of 1280×720, the RGB color image stream would result in a data stream of (1280·720·3·120)/(1024·1024) MB/s=316.4 MB/s. Continuously analyzing such data streams is not feasible with portable computing devices (7, 118), such as smart telephones and tablet computers, as this would drain device batteries quickly and/or result in an ever-increasing time delay in the portable computing devices that do not have enough processing power for a real-time analysis.

Thanks to the detection of the beginning of the event of interest and the stopping criterion, the amount of the image data is significantly reduced and the computation is focused on meaningful data only. This also significantly reduces the power consumption of the computing device (7, 118). Moreover, further reductions to the computational burden of the computing device (7, 118) can be achieved by using prior information, for example, such as an expected time when the projectile (10, 104) enters and leaves the image space (6) and an expected location of the projectile (10, 104) at different instants of time. This prior information can be obtained, for example, from the results of the preceding events of interest and/or from application-specific conditions. An example of an application specific condition could be knowledge that the imaging device (8, 120) is placed on the ground such as in FIG. 2. This means that the projectile (10, 104) is expected to enter the image space (6) from a top of the image space (6) where the projectile (10, 104) is first visible.

Moreover, determining the 3D position coordinates of the projectile (10, 104) from its projection on the image plane of the imaging device (8, 120) is possible when real dimensions of the projectile (10, 104) are known and the imaging device (8, 120) is properly calibrated. For the sake of simplicity, it is assumed that the imaging device (8, 120) is fully calibrated and conforms to a simple pinhole camera projection model. It is to be noted here that other projection models can also be used without deviating from the scope of the present disclosure.

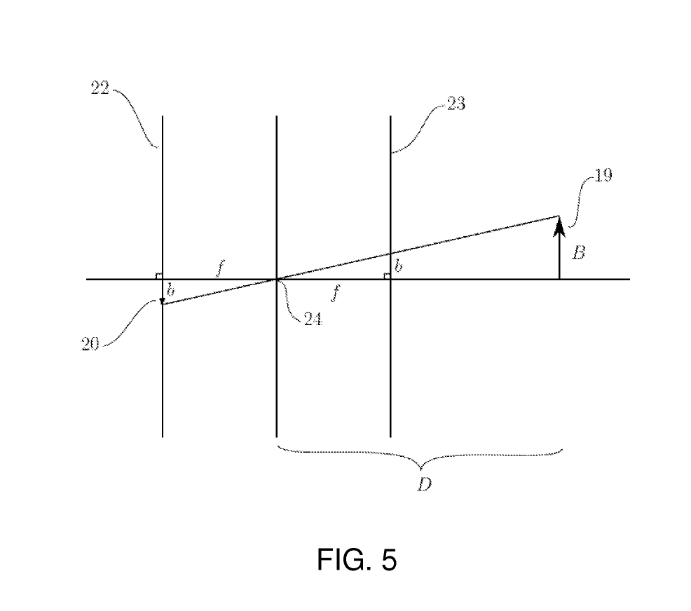

FIG. 5 is a schematic illustration of a pinhole camera projection model. In a pinhole camera, all rays of light pass through a single point called an optical centre 24 of the pinhole camera.

As can be seen in FIG. 5, a size of an object 19 and a size of its projection 20 are connected through an equation below:

$$\frac{b}{f} = \frac{B}{D} ,$$

where
‘B’ represents the size of the object 19,
‘b’ represents the size of the projection 20,
‘f’ represents a focal length of the pinhole camera, and
‘D’ represents a distance of the object 19 from the optical centre 24 of the pinhole camera.

Since ‘f’ and ‘B’ are known and ‘b’ can be measured from a given image, it is possible to solve the distance ‘D’.

Moreover, the object 19 is projected upside down in an actual image plane 22, as shown in FIG. 5. However, for calculation purposes, a virtual image plane 23 can be used instead of the actual image plane 22. Thus, the above equation also remains the same for the virtual image plane 23.

FIG. 5 is merely an example, which should not unduly limit the scope of the claims herein. A person skilled in the art will recognize many variations, alternatives, and modifications of embodiments of the present disclosure.

There will now be described an example of how the 3D position coordinates of the projectile (10, 104) can be determined. It is to be noted here that other ways of determining the 3D position coordinates can also be used, without deviating from the scope of the present disclosure.

FIG. 6 is a schematic illustration of a pinhole projection 20 of a spherical projectile 10, in accordance with an embodiment of the present disclosure. The projection 20 of the projectile 10 is depicted by a thicker line on the virtual image plane 23.

From similar triangles, a following equation is obtained:

$$\frac{x}{y} = \frac{R}{D} . \qquad ( 1 )$$

where
‘R’ represents a radius of the projectile 10, and
‘D’ represents a distance of the projectile 10 from the optical centre 24.

The distance ‘D’ is solvable by trigonometry, using following equations:

$$\begin{matrix}α = {tan}^{- 1} ( \frac{g}{f} ) , \\ β = \frac{{tan}^{- 1} ( \frac{h}{f} ) - α}{2} , & ( 2 ) \\ sin β = \frac{x}{y} & ( 3 ) \\ ⇒ D = \frac{R}{sin β} . & ( 4 )\end{matrix}$$

where
‘g’ represents a distance of a nearest edge of the projection 20 from an image centre 21, and
‘h’ represents a distance of a farthest edge of the projection 20 from an image centre 21.
As the distances ‘g’ and ‘h’ are measurable from a given image, and the focal length ‘f’ and the radius ‘R’ are known, the distance ‘D’ can be determined

The 3D position coordinates of the projectile 10 is computed from a following equation:

B_{3D}=Du

where
‘u’ is a unit vector to a direction of the line from the optical centre 24 to a centre of the projectile 10.

The unit vector ‘u’ can be solved as

$$u = {\frac{1}{\sqrt{{c}_{x}^{2} + {c}_{y}^{2} + {f}^{2}}} [ \begin{matrix}{c}_{x} & {c}_{y} & f\end{matrix} ]}^{T} . \qquad ( 3 )$$

where
‘cₓ’ and ‘c_{y}’ are x and y coordinates of a midpoint 25 of the projection 20.

Furthermore, methods of finding the projection 20 of the projectile 10 within the given image are numerous and well-known in the art. Some of the methods are based on color information, shape, background subtraction, Hough circles, template matching, and/or other image features, but not limited thereto. Each of these methods can be employed alone or in a combination with some other methods to find the projection 20 of the projectile 10 within the given image. Additionally, optionally, machine learning and pattern recognition techniques can also be used. Applicable methods for finding the projection 20 of the projectile 10 are not limited to these mentioned here. A person skilled in the art will recognize many variations, alternatives, and modifications of the methods employed to find the projection 20 of the projectile 10 within the given image.

Additionally, optionally, intermediate position coordinates of the projectile 10 can be derived by interpolating possible positions of the projectile 10 between two successive images, if required. Such interpolation can be performed using methods similar to as used in video compression standards for calculating intra images.

FIG. 6 is merely an example, which should not unduly limit the scope of the claims herein. A person skilled in the art will recognize many variations, alternatives, and modifications of embodiments of the present disclosure.

### Phase 5: Determination of the Time-Parameterized Trajectory

The time-parameterized trajectory (1) of the projectile (10, 104) is determined using the sensor data and a sufficient amount of initial and/or boundary conditions. Given that all typical events of interest in the scope of the present disclosure are completed in a matter of few seconds, it is reasonable to neglect effects caused by a rotation of the Earth, and also to assume that the gravitational acceleration (g) is a constant. These simplifications are not mandatory, but typically their effect is insignificant. This makes it feasible to present an underlying inertial navigation problem in much simplified terms.

When using, for example, direction cosine matrices, C(t), to represent an attitude (namely, an orientation) of a body-fixed coordinate frame, B, moving and rotating along with the projectile (10, 104) with respect to an Earth-fixed local geographic frame, E, namely a global coordinate frame defined in the calibration phase, it holds for a time derivative Ċ(t) that

Ċ_{B}^{E}(t)=C_{B}^{E}(t)[ω(t)]ₓ, (6)

where

$${[ ω ( t ) ]}_{x} = [ \begin{matrix}0 & - {ω}_{z} ( t ) & {ω}_{y} ( t ) \\ {ω}_{z} ( t ) & 0 & - {ω}_{x} ( t ) \\ - {ω}_{y} ( t ) & {ω}_{x} ( t ) & 0\end{matrix} ] . \qquad ( 7 )$$

and where
‘ωₓ(t)’, ‘ω_{y}(t)’, and ‘ω_{z}(t)’ represent measurements of a triaxial angular rate sensor included within the projectile (10, 104).

For an orthogonal matrix with nonnegative determinant, it holds that

C_{B}^{E}(t)[C_{B}^{E}(t)]^{T}=[C_{B}^{E}(t)]^{T}C_{B}^{E}(t)=1, det(C_{B}^{E}(t))=+1∀tε[T₀,T₁]

For a second time derivative of a position ‘p(t)’ of the projectile (10, 104), it holds that

$$\ddot{p} ( t ) = {C}_{B}^{E} ( t ) [ \begin{matrix}{f}_{x} ( t ) \\ {f}_{y} ( t ) \\ {f}_{z} ( t )\end{matrix} ] + g . \qquad ( 8 )$$

where
‘fₓ(t)’, ‘f_{y}(t)’, and ‘f_{z}(t)’ represent measurements of a triaxial accelerometer included within the projectile (10, 104).

Now, equations (6) and (8) can further be written in a following form:

$$[ \begin{matrix}{\dot{c}}_{1} ( t ) \\ {\dot{c}}_{2} ( t ) \\ {\dot{c}}_{3} ( t ) \\ \dot{v} ( t ) \\ \dot{p} ( t )\end{matrix} ] = [ \begin{matrix}0 & {ω}_{z} ( t ) I & - {ω}_{y} ( t ) I & 0 & 0 \\ - {ω}_{z} ( t ) I & 0 & {ω}_{x} ( t ) I & 0 & 0 \\ {ω}_{y} ( t ) I & - {ω}_{x} ( t ) I & 0 & 0 & 0 \\ {f}_{x} ( t ) I & {f}_{y} ( t ) I & {f}_{z} ( t ) I & 0 & 0 \\ 0 & 0 & 0 & I & 0\end{matrix} ] [ \begin{matrix}{c}_{1} ( t ) \\ {c}_{2} ( t ) \\ {c}_{3} ( t ) \\ v ( t ) \\ p ( t )\end{matrix} ] + [ \begin{matrix}0 \\ 0 \\ 0 \\ y \\ 0\end{matrix} ] . , \qquad ( 9 )$$

where

C_{B}^{E}(t)=[c₁(t)c₂(t)c₃(t)]

Differential-algebraic equation (9) reveals a connection between the attitude ‘C(t)’, a velocity ‘v(t)’, and the position ‘p(t)’ of the projectile (10, 104), and forms a basis for determining the time-parameterized trajectory (1) of the projectile (10, 104) for all tε[T₀, T₁]. A kind of a problem so formed is often referred to as a fixed-interval smoothing problem.

With a suitable set of initial or boundary conditions, the differential-algebraic equation (9) can be solved for all tε[T₀, T₁]. Conventionally, for example, such as in the referred US patent application 20140045630 A1, the equation (9) is solved by providing initial conditions ‘C(T₀)’, ‘v(T₀)’, and ‘p(T₀)’. However, given that there are significant amount of errors both in the measurements of ‘ω(t)’ and ‘f(t)’ and in the provided initial conditions, the errors will grow with increasing ‘t’. This leads to an intolerable position error at a critical time when the projectile (10, 104) passes through the specified region in space (9, 116).

According to an embodiment, the aforementioned fixed-interval smoothing problem is solved as a boundary-value problem rather than a conventional initial-value problem. As a result, the problem of increasing error is significantly reduced, due to reasonably accurate estimates of the position coordinates of the projectile (10, 104) provided by the aforementioned image sequence analysis at some points of the trajectory (1). Moreover, it is not necessary to provide the initial conditions ‘C(T₀)’, ‘v(T₀)’, and ‘p(T₀)’, and additional velocity constraints during the event of interest, namely taking place when tε[T₀, Tᵣ].

Furthermore, given that the aforementioned problem has nine degrees of freedom, namely three for the position, three for the velocity, and three for the attitude, at least nine boundary conditions should be provided to obtain a unique solution to the problem. As the aforementioned problem has algebraic constraints, not all combinations of boundary values yield a unique solution. However, in practice, this does not pose a significant problem, as application-specific knowledge can be used to select a correct solution. If more than nine boundary conditions are available, all the boundary conditions can be used to increase an accuracy of the solution.

An example of boundary conditions that are sufficient to accurately determine the time-parameterized trajectory (1) of the projectile (10, 104) without a need for the initial conditions ‘C(T₀)’, ‘v(T₀)’, and ‘p(T₀)’ has been provided below. In this example, distinct values ‘p(Tₐ)’, ‘p(T_{b})’ and ‘p(T_{c})’, where Tₐ, T_{b}, T_{c}ε[T₀, T₁], possibly provided by the aforementioned image sequence analysis can be provided.

In contrast to the conventional initial-value problem, the position, velocity, and attitude errors no longer increase with time, and are instead evenly distributed over the range tε[T₀, T₁], thereby yielding a significantly lower maximum error.

In a case where the sequence of still images realises as a single image, other boundary values can be obtained, for example, from a knowledge of initial velocity and position of the projectile (10, 104) or from a known physical constraint. In an example where the projectile (10, 104) rolls or slides on the ground, a known physical constraint can be that a height of the projectile (10, 104) is a constant.

Examples of tools that are capable of solving the aforementioned boundary-value problem include, but are not limited to, a Wiener-Kolmogorov filter and some forms of a particle filter. It is to be noted here that the abovementioned examples are not the only possible tools that are capable of solving the aforementioned boundary-value problem, but are merely example tools that could be used. For example, in some special cases, the aforementioned problem can be formulated as the initial-value problem, which can then be solved using standard tools, such as a Rauch-Tung-Striebel smoother, a two-filter smoother and a Bryson-Frazier smoother.

### Phase 6: Analysis of the Time-Parameterized Trajectory

Once the time-parameterized trajectory (1) of the projectile (10, 104) is determined, the time-parameterized trajectory (1) is compared with the location of the specified region in space (9, 116) to determine whether the projectile (10, 104) passed through the specified region in space (9, 116).

Additionally, optionally, the time-parameterized trajectory (1) is analyzed to determine the one or more event-specific metrics. The one or more event-specific metrics may, for example, include one or more of: a maximum speed of the projectile (10, 104), an amount of spin of the projectile (10, 104), a rotation axis of the projectile (10, 104), a rotation rate of the projectile (10, 104), and/or a location of the projectile (10, 104) at the specified region in space (9, 116).

Moreover, a form of the time-parameterized trajectory (1) and an evolution of the speed of the projectile (10, 104) during the event of interest reveal valuable information about a performance of a player.

### Phase 7: Data Collection

Optionally, the results of the analysis of the time-parameterized trajectory (1) are collected into a database for future reference and/or performance analysis. These results may, for example, include at least one of: the time-parameterized trajectory (1), an indicator of whether the time-parameterized trajectory (1) intersected with the specified region in space (9, 116), and/or the one or more event-specific metrics.

Moreover, optionally, a last determined trajectory can be used as an initial prediction for a next event of interest.

### Phase 8: Repeat Phase 2

After the abovementioned analysis is complete, the sports apparatus returns to Phase 2 and waits for a next event of interest to be detected.

### Possible Sensor Combinations

In a case where the configuration of sensors includes an accelerometer only, the aforementioned phases, including the detection of the event of interest, are performed as explained above using accelerometer data only. In this case, pure inertial navigation is not possible, as there are no means to determine the attitude of the projectile (10, 104). Therefore, the dynamics of the projectile (10, 104) are estimated based on known mechanical models of flying projectiles and the position estimates provided by the image sequence analysis can be used to filter an estimated trajectory (1). However, in this case, an accuracy of the estimated trajectory (1) is decreased, and estimation of spin and rotation speed of the projectile (10, 104) is generally unfeasible.

In another case where the configuration of sensors includes an accelerometer and a magnetometer, magnetometer data can be used to compensate a dynamical range of an angular rate sensor. The dynamical range of the angular rate sensor may be insufficient in some applications where the rotation speed of the projectile (10, 104) is particularly high. Otherwise, the magnetometer data can be used to increase the accuracy of attitude estimates of the projectile (10, 104). In cases where no angular rate sensor is used, the magnetometer can be used together with the accelerometer to emulate an angular rate sensor.

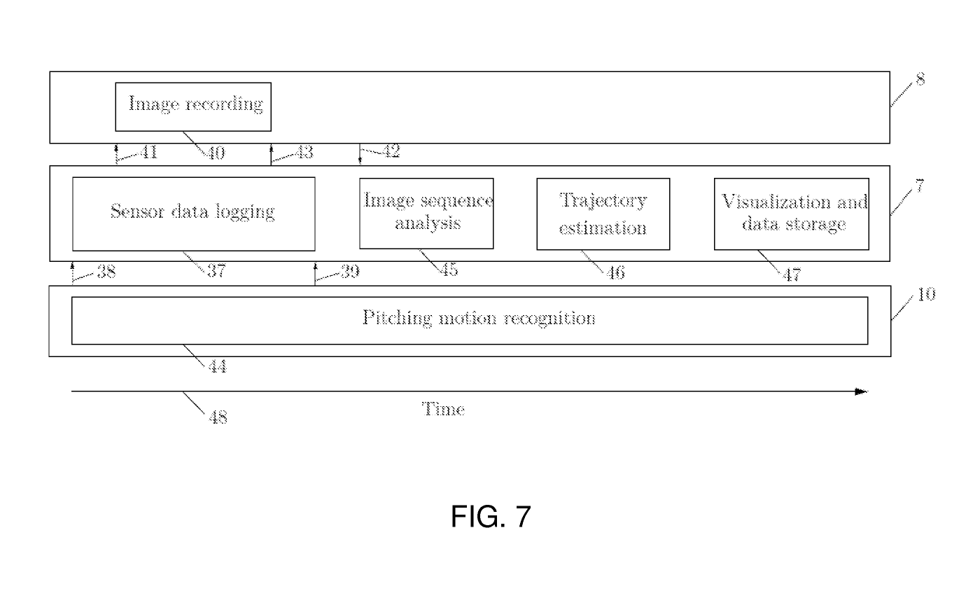

FIG. 7 is an illustration of the abovementioned phases 2 to 7 with increasing time 48, in accordance with an embodiment of the present disclosure. For illustration purposes only, the phases 2 to 7 have been described with reference to a case where an event of interest is a pitching motion.

At the phase 2, a pitching motion detection process 44 takes place. The pitching motion detection process 44 provides a start signal 38 and a stop signal 39 for a sensor data logging process 37. The sensor data logging process 37 further provides a start signal 41 and a stop signal 43 (at the phase 3) for an image recording process 40.

A sequence of still images 42 recorded during the image recording process 40 is then transferred from the imaging device (8, 120) to the computing device (7, 118).

Thereafter, at the phase 4, an image sequence analysis process 45 is performed.

Subsequently, at the phases 5 and 6, a trajectory estimation process 46 is performed.

Finally, at the phase 7, a visualization and data storage process 47 if performed.

FIG. 7 is only illustrative and other alternatives can also be provided where one or more phases are added, one or more phases are removed, or one or more phases are provided in a different sequence without departing from the scope of the claims herein.

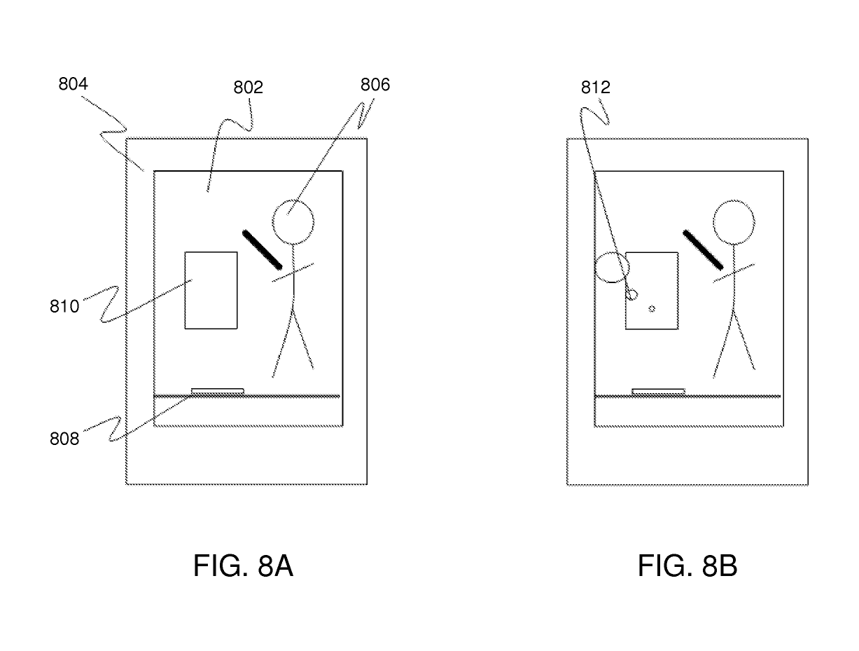

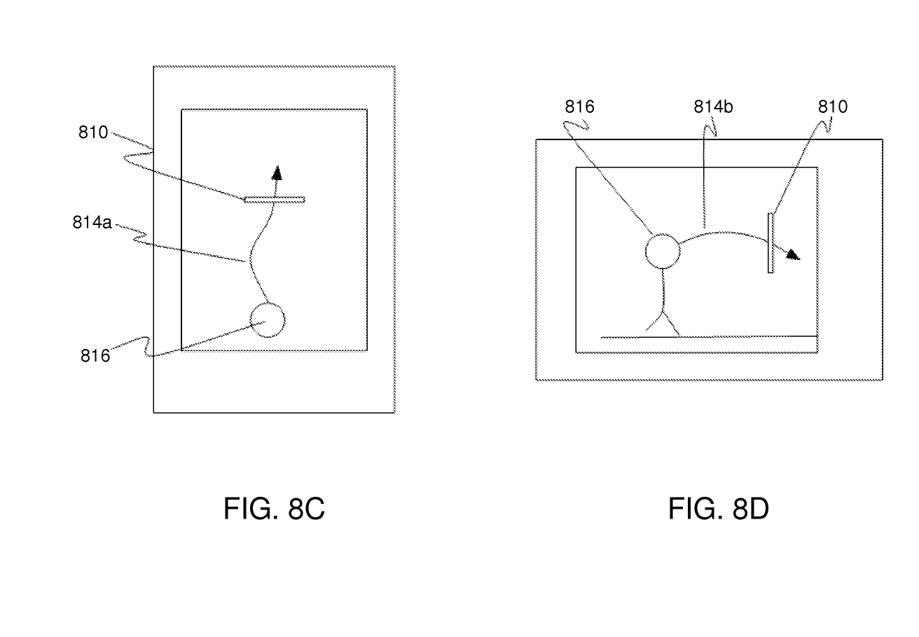

There will next be provided an example user interface displaying a time-parameterized trajectory (1). FIGS. 8A-D are schematic illustrations of an example user interface 802, in accordance with an embodiment of the present disclosure. With reference to FIGS. 8A-D, the user interface 802 is rendered on a display of a computing device 804. Optionally, the display of the computing device 804 is a touchscreen. A software application running on the computing device 804 is configured to control the user interface 802.

In FIG. 8A, the user interface 802 displays a camera view, namely augmented reality, showing a batter 806 and a home plate 808. The user interface 802 displays a virtual strike zone 810, namely a specified region in space, over the camera view.

With reference to FIG. 8B, the user interface 802 displays projections 812 of a projectile at different instants of time. The projections 812 may, for example, be found in a recorded sequence of still images, as described earlier in conjunction with FIG. 6.

In FIG. 8C, the user interface 802 displays a time-parameterized trajectory 814a of the projectile as seen from a top. The user interface 802 also displays a pitcher 816, who has pitched the projectile.

In FIG. 8D, the user interface 802 displays a time-parameterized trajectory 814b of the projectile as seen from a side.

As shown in FIGS. 8C-D, the projectile passes through the strike zone 810, namely the specified region in space.

FIGS. 8A-D are merely examples, which should not unduly limit the scope of the claims herein. A person skilled in the art will recognize many variations, alternatives, and modifications of embodiments of the present disclosure.

Embodiments of the present disclosure are susceptible to being used for various purposes, including, though not limited to, enabling accurate determination of a time-parameterized trajectory of a projectile, while reducing power consumption of a sports apparatus.

As further clarifications the projectile might contain at least a triaxial accelerometer and optionally a triaxial angular rate sensor (i.e. gyroscope) and/or a triaxial magnetometer. Moreover, a computing device might contain or be in control of either a camera, a video camera or an imaging device capable of shooting stills and/or videos, including devices operating on frequencies other than visible light (such as an infrared camera). The term “sequence of still images” can refer also recorded movies and/or videos without departing from the scope of the present disclosure. The term “imaging device” can refer to the device recoding the mentioned sequence of still images. It should be noted that in some situations, the mentioned sequence of still images may realise as a single image.

A term “a pitch of a ball” (the projectile) in the game of baseball is used to illustrate some of the embodiments. Embodiments are not limited the baseball but can be applied to other sports including but not limited to football, baseball, bowling, lacrosse, handball, volleyball, soccer, tennis, and ice hockey. In baseball, the event of interest starts e.g. when the pitcher initiates the pitching motion and stops e.g. when the distance between the ball and the goal structure starts increasing. Moreover the projectile can contain one or more sensors such as a triaxial accelerometer and a triaxial gyroscope, forming a six-axis inertial measurement unit (IMU). The projectile can also contain one or more of an accelerometer, a magnetometer, an angular rate sensor.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A sports apparatus for determining a time-parameterized trajectory of a projectile and determining whether the time-parameterized trajectory intersects a specified region in space, the sports apparatus comprising:
a computing device;
an imaging device; and
a projectile, comprising:
a configuration of sensors for collecting sensor data; and
a wireless interface for communicating the sensor data to the computing device,
wherein the computing device is operable to use the sensor data to detect a beginning of an event of interest, and to use the imaging device to start recording a sequence of still images along an expected trajectory of the projectile based on the detected beginning of the event of interest,
wherein the sequence of still images comprises at least one image where the projectile is detectable,
further wherein the computing device is operable to use the at least one image and the sensor data to determine a time-parameterized trajectory of the projectile, and to determine whether the time-parameterized trajectory intersects a specified region in space.

2. A sports apparatus of claim 1, wherein the sensor data comprises accelerometer data, angular rate sensor data, and magnetometer data.

3. A sports apparatus of claim 1, wherein the sensor data comprises accelerometer data and angular rate sensor data.

4. A sports apparatus of claim 1, wherein the sensor data comprises accelerometer data and magnetometer data.

5. A sports apparatus of claim 1, wherein the sensor data comprises accelerometer data.

6. A sports apparatus of claim 1, wherein the computing device is operable to process the time-parameterized trajectory to determine one or more event-specific metrics.

7. A sports apparatus of claim 1, wherein the computing device is operable to detect an image position and an image size of the projectile at one or more images of the sequence of still images to estimate position coordinates of the projectile.

8. A sports apparatus of claim 1, wherein the imaging device is operable to record the sequence of still images using frequencies other than visible light.

9. A sports apparatus of claim 1, wherein the computing device comprises a user interface for determining the specified region in space and calibrating the sports apparatus.

10. A sports apparatus of claim 9, wherein the computing device is operable to employ the user interface to indicate, within an image range of the imaging device, a presence of a physical goal structure with known physical dimensions.

11. A sports apparatus of claim 9, wherein the computing device is operable to detect an object with known dimensions, and to employ the user interface to specify borders of the specified region in space using the detected object.

12. A sports apparatus of claim 9, wherein the computing device is operable to use a specific calibration structure with known dimensions, and to employ the user interface to define a location of the specific calibration structure.

13. A sports apparatus of claim 1, wherein
the projectile is a ball selected from a group consisting of a baseball, a softball and a cricket ball,
the event of interest is a pitch or a strike of the ball, and
the specified region in space is a strike zone above a home plate or an area in front of a wicket.

14. A sports apparatus of claim 1, wherein
the projectile is a tennis ball or a volleyball,
the event of interest is a serve or a hit of the tennis ball or the volleyball, and
the specified region in space is a region above a net or a region defined within a court.

15. A sports apparatus of claim 1, wherein
the projectile is selected from a group consisting of a hockey puck, a lacrosse ball and a handball,
the event of interest is a shot of the projectile, and
the specified region in space is a goal.

16. A sports apparatus of claim 1, wherein
the projectile is a soccer ball or a football,
the event of interest is a kick of the soccer ball or the football, and
the specified region in space is a goal.

17. A sports apparatus of claim 1, wherein
the projectile is a golf ball,
the event of interest is a hit of the golf ball, and
the specified region in space is selected from a group consisting of a green, a flag and a hole.

18. A sports apparatus of claim 1, wherein
the projectile is a bowling ball,
the event of interest is a shot of the bowling ball, and
the specified region in space is a region defined at an end of a bowling lane.

19. A sports apparatus of claim 1, wherein
the projectile is a basketball,
the event of interest is a shot of the basket ball, and
the specified region in space is a region inside a rim.

20. A sports apparatus of claim 1, wherein the specified region in space is defined arbitrarily.

21. A computer-implemented method for determining a time-parameterized trajectory of a projectile and determining whether the time-parameterized trajectory intersects a specified region in space, the projectile comprising a configuration of sensors, the method comprising:
(a) receiving sensor data from the projectile;
(b) using the sensor data to detect a beginning of an event of interest;
(c) starting recording of a sequence of still images along an expected trajectory of the projectile based on the detected beginning of the event of interest, wherein the sequence of still images comprises at least one image where the projectile is detectable;
(d) using the at least one image and the sensor data to determine the time-parameterized trajectory of the projectile; and
(e) determining whether the time-parameterized trajectory intersects the specified region in space.

22. A method of claim 21, wherein the sensor data comprises accelerometer data, angular rate sensor data, and magnetometer data.

23. A method of claim 21, wherein the sensor data comprises accelerometer data and angular rate sensor data.

24. A method of claim 21, wherein the sensor data comprises accelerometer data and magnetometer data.

25. A method of claim 21, wherein the sensor data comprises accelerometer data.

26. A method of claim 21, wherein the method further comprises processing the time-parameterized trajectory to determine one or more event-specific metrics.

27. A method of claim 21, wherein the method further comprises detecting an image position and an image size of the projectile at one or more images of the sequence of still images to estimate position coordinates of the projectile.

28. A method of claim 21, wherein the sequence of still images is recorded using frequencies other than visible light.

29. A method of claim 21, wherein the method further comprises providing a user interface for determining the specified region in space.

30. A method of claim 29, wherein the method further comprises employing the user interface to indicate, within an image range, a presence of a physical goal structure with known physical dimensions.

31. A method of claim 29, wherein the method further comprises detecting an object with known dimensions, and employing the user interface to specify borders of the specified region in space using the detected object.

32. A method of claim 29, wherein the method further comprises using a specific calibration structure with known dimensions, and employing the user interface to define a location of the specific calibration structure.

33. A method of claim 21, wherein
the projectile is a ball selected from a group consisting of a baseball, a softball and a cricket ball,
the event of interest is a pitch or a strike of the ball, and
the specified region in space is a strike zone above a home plate or an area in front of a wicket.

34. A method of claim 21, wherein
the projectile is a tennis ball or a volleyball,
the event of interest is a serve or a hit of the tennis ball or the volleyball, and
the specified region in space is a region above a net or a region defined within a court.

35. A method of claim 21, wherein
the projectile is selected from a group consisting of a hockey puck, a lacrosse ball and a handball,
the event of interest is a shot of the projectile, and
the specified region in space is a goal.

36. A method of claim 21, wherein
the projectile is a soccer ball or a football,
the event of interest is a kick of the soccer ball or the football, and
the specified region in space is a goal.

37. A method of claim 21, wherein
the projectile is a golf ball,
the event of interest is a hit of the golf ball, and
the specified region in space is selected from a group consisting of a green, a flag and a hole.

38. A method of claim 21, wherein
the projectile is a bowling ball,
the event of interest is a shot of the bowling ball, and
the specified region in space is a region defined at an end of a bowling lane.

39. A method of claim 21, wherein
the projectile is a basketball,
the event of interest is a shot of the basketball, and
the specified region in space is a region inside a rim.

40. A method of claim 21, wherein the specified region in space is defined arbitrarily.

41. A computer program product comprising a non-transitory computer-readable data storage medium having stored thereon computer-readable program code, which is executable by a processor of a computing device to implement a method of claim 21.
